(19) United States
(12) Patent Application Publication
(10) Pub. No.: US 2017/0228374 A1
(43) Pub. Date: Aug. 10, 2017

(54) Diversification and Filtering of Search Results

(71) Applicant: Microsoft Technology Licensing, LLC, Redmond, WA (US)

(72) Inventors: Puneet Agrawal, Hyderabad (IN); Divya Jetley, Bellevue, WA (US); Kedhar Nath Narahari, Hyderabad (IN)

(21) Appl. No.: 15/018,516

(22) Filed: Feb. 8, 2016

(51) Int. Cl. G06F 17/30

(52) U.S. Cl. CPC G06F 17/3053; G06F 17/30864; G06F 17/30554

(57) ABSTRACT

Systems and methods, and computer-readable media embodying the systems and methods, for responding to a search query from a computer user with diversified search results are presented. In response to a search query, a set of search results that satisfy the search query are identified. The set of search results are re-ordered according to diversity criteria associated with the requesting computer user. The diversity criteria may comprise any of a sentiment, a content source, and/or ratios thereof. One or more search results pages are generated according to the set of re-ordered search results and returned to the requesting computer user in response to the search query.

### BACKGROUND

Currently, search engines (or online search services) provide a requesting computer user with a set of search results (each search result being a hyperlink to a corresponding online document or content) considered relevant and responsive to a given search query. Generally speaking, the set of search results are typically ranked or ordered according relevance of the content/document to the search query, popularity of the corresponding content/document and, in limited cases, a diversity of intent of the computer user in submitting the search query.

The corpus of content on web is growing at a rapid, likely exponential, pace, and a large portion of the new content available on the internet comprises of user-generated content. User-generated content may include, by way of illustration and not limitation, personal reviews of a variety of items such as movies, political situations, restaurants, and so on. Naturally these user-generated content items often carry the author's sentiment or opinion with regard to the reviewed item, some denoting positive opinions, some denoting negative opinions, and even some may indicate that the author was neutral and/or indifferent.

In the context of search results that include results directed to user-generated content, if the reviews/user-generated content items having a positive (or negative) sentiment are more popular, the search engine's results would naturally largely comprise content items having positive (or negative) sentiments. The result of the popularity would be that user-generated content having alternative or neutral views would be obscured and/or masked, even though they may represent valuable information that would be desired among a set of search results.

Similarly, the source of user-generated content also may mask or obscure valuable information that would be desired in a set of search results. For example, computer users often turn to popular, often commercial, sources for information regarding particular venues, such as a hotel. While there are several popular sources that provide hotel information in the form of user feedback and ratings (which are forms of user-generated content), quite often valuable information may be found in individuals' blogs (also user-generated content) but, due to a typical lack of popularity, the information is not surfaced in a search results set.

### SUMMARY

The following Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

According to aspects of the disclosed subject matter, systems and methods, and computer-readable media embodying the systems and methods, for responding to a search query from a computer user with diversified search results are presented. In response to a search query, a set of search results that satisfy the search query are identified. The set of search results are re-ordered according to diversity criteria associated with the requesting computer user. The diversity criteria may comprise any of a sentiment, a content source, and/or ratios thereof. One or more search results pages are generated according to the set of re-ordered search results and returned to the requesting computer user in response to the search query.

According to additional aspects of the disclosed subject matter, a method, as implemented on a computing device, for responding to a search query from a computer user with diversified search results is presented. In response to a search query from the computer user, a set of search results that satisfy the search query is identified. The set of search results are identified according to the query terms of the search query, and the set of search results is an ordered set of search results. The set of search results are then re-ordered according to diversity criteria and at least one search results page is generated according to the re-ordered set of search results. The search results page is returned in response to the search query.

According to further aspects of the disclosed subject matter, computer-readable medium bearing computer-executable instructions is provided. The computer-executable instructions, when executed on a computing system comprising at least a processor, carry out a method for responding to a search query from a computer user with diversified search results. The method comprises identifying a set of search results that satisfy the search query according to the query terms of the search query. The set of search results is an ordered set of search results, ordered according to a score associated with each search result in regard to the search query. The set of search results is re-ordered according to diversity criteria. Re-ordering the set of search results according to diversity criteria comprises modifying the score of each search results of the set of search results according to the diversity criteria, and ordering the set of search results according the modified scores of the search results. At least one search results page is generated according to the re-ordered set of search results and at least one search results page is returned in response to the search query.

According to still further aspects of the disclosed subject matter, a computer system for responding with diversified search results to a search query from a computer user is presented. The computer system includes a processor and a memory, where the processor executes instructions stored in the memory as part of or in conjunction with additional components to respond to a search query. These additional components include, at least, a search query module, a search results identification module, a search results diversification module, a content classifier, and a search results page generator. In execution, the search query module receives a search query from the computer user and responds to the computer user with one or more of the generated search results pages. For its part, the search results identification module identifies a set of ordered search results that satisfy the search query from the computer user. The search results diversification module re-orders the set of ordered search results of the search results identification module according to diversity criteria associated with the computer user. The content classifier identifies diversification attributes, including content sentiment, content source, and user-generated content of content referenced by the set of ordered search results, upon which diversification attributes the search results diversification module relies. The search results page generator generates one or more search results according to the re-ordered set of search results.

### BRIEF DESCRIPTION OF THE DRAWINGS

The foregoing aspects and many of the attendant advantages of the disclosed subject matter will become more readily appreciated as they are better understood by reference to the following description when taken in conjunction with the following drawings, wherein:

FIG. 1 is a block diagram illustrating an exemplary process, as executed on a suitably configured search engine, for responding to a search query from a user according to aspects of the disclosed subject matter;

FIG. 2 is a flow diagram illustrating an exemplary routine for responding to a search query from a user according to aspects of the disclosed subject matter;

FIG. 3 is a block diagram illustrating an exemplary computer readable medium encoded with instructions to operate a search engine according to aspects of the disclosed subject matter;

FIG. 4 is a block diagram illustrating an exemplary computing device configured as a search engine according to aspects of the disclosed subject matter; and

FIG. 5 is a block diagram illustrating an exemplary network environment suitable for implementing aspects of the disclosed subject matter

### DETAILED DESCRIPTION

For purposed of clarity, the use of the term “exemplary” in this document should be interpreted as serving as an illustration or example of something, and it should not be interpreted as an ideal and/or leading illustration of that thing. Stylistically, when a word or term is followed by “(s)”, the meaning should be interpreted as indicating the singular or the plural form of the word or term, depending on whether there is one instance of the term/item or whether there is one or multiple instances of the term/item. For example, the term “user(s)” should be interpreted as one or more users.

The term “search query” should be interpreted as a submission from a computer user to a search engine that serves as a request from the computer user to the search engine for content that satisfies and/or is relevant to the query terms (the basis of the search query) of the search query. The content that the search engine (also referred to as an online search service) returns typically includes a set of search results and, optionally, other information relevant to and/or responsive to the search query. For purposes of clarity, a search result is a reference (typically in the form of a hyperlink) to a content item/document that is accessible to the computer user over the network. The search results may include some portion of the referenced content as a descriptive “snippet” such that the requesting computer user can consider whether the referenced content represents the desired content.

According to aspects of the disclosed subject matter, systems, methods, processes and the like are presented with regard to diversifying search results according to various diversity criteria, particularly (though not exclusively) with regard to user-generated content. According to various embodiments, the diversity criteria may be provided by the computer user requesting search results by way of a search query, i.e., user-supplied diversity criteria. The user-supplied diversity criteria may be stored as one or more user preferences of the computer user by a search engine. According to various embodiments, the user-supplied diversity criteria may include, by way of illustration and not limitation, a sentiment with regard to the content and/or source information. Examples of sentiment include (by way of illustration and not limitation): a positive sentiment expressing a positive or favorable view and/or attitude with regard to all or some of the subject matter of the content; a negative sentiment expressing a negative or unfavorable view and/or attitude with regard to all or some of the subject matter of the content; and a neutral sentiment in which the particular subject matter of the content generally does not express either a positive or a negative view/attitude. In addition to sentiment, the user-supplied diversity criteria may also include an indication to a source type, such as a commercial or non-commercial source. Examples of commercial sources include sources whose primary purpose of hosting (or otherwise making available) user-generated content is for commercial purposes such as social networking sites/services, review services, news sources, and the like. In contrast to commercial sources, non-commercial sources include, by way of illustration and not limitation, user blogs, independent postings, and the like.

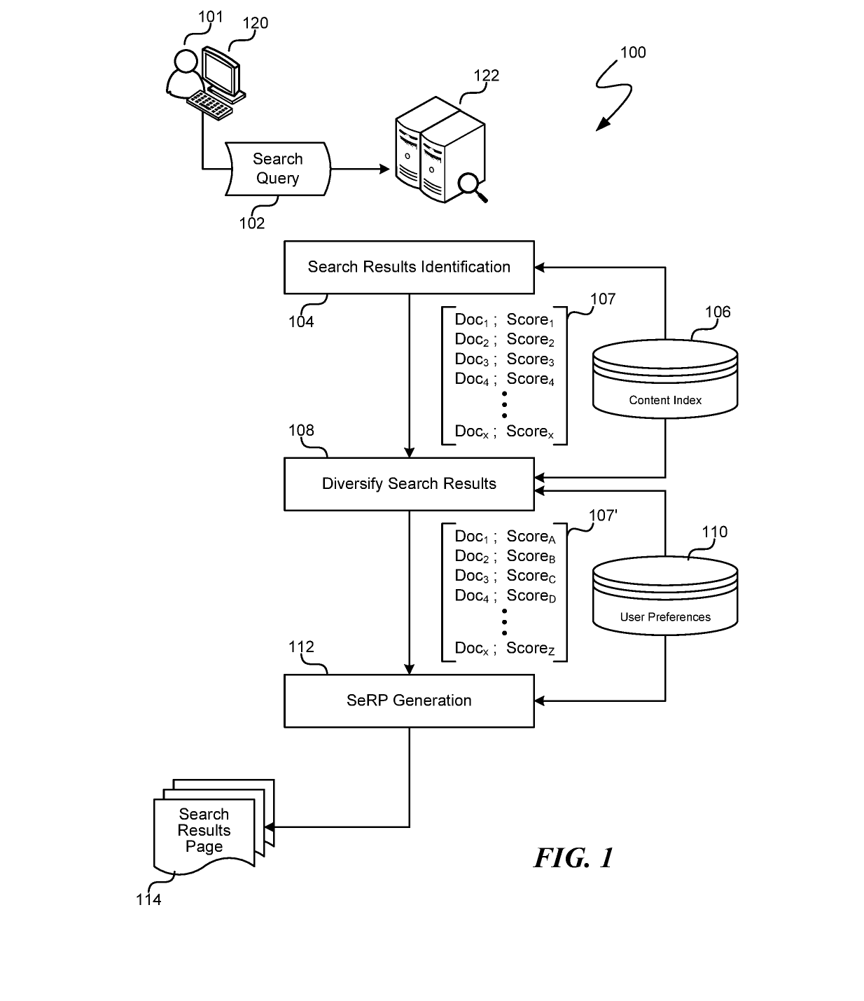

To illustrate the process of responding to a search query from a computer user with diversified search results, especially in regard to user-generated content, reference is now made to the figures. FIG. 1 is a block diagram illustrating an exemplary process 100, as executed on a suitably configured search engine, for responding to a search query from a user in accordance with aspects of the disclosed subject matter. As will be appreciated, a computer user 101 (by way of the user computer 120) will submit a search query 102 to a search engine 122. In response to the search query and as indicated by block 104, the search engine 122 identifies search results from a content index 106 that are relevant/related to the search query according to the query terms) of the search query 102. Search results that are relevant and/or related to the search query as said to be search results that that satisfy the search query, i.e., search results that are deemed to satisfy the query intent of the search query based on the query terms) of the search query. By way of illustration, search results set 107 illustrates an exemplary set of search results retrieved by the search engine in response to the search query 102. As can be seen, the search results set 107 includes the content items identified as satisfying the search query and a corresponding relevance score, e.g., Doc1 has a relevance score of Score1, Doc2 has a relevance score of Score2, etc. Generally speaking, the relevance score is a relative value signifying the strength of relevance of the referenced content to the subject matter of the search query 102.

According to aspects of the disclosed subject matter, the identified content is then diversified according to diversity criteria (including user-supplied diversity criteria), as shown in block 108. As indicated above, the user-supplied diversity criteria is obtained from user preferences (temporarily and explicitly supplied or based on established preferences in a user preferences store 110). In particular and according to aspects of the disclosed subject matter, the personalization is made in accordance with the computer user's preferences in regard to sentiment and/or content source. In this personalization ranking, the scores corresponding to the identified documents of search results set 109 are modified according to the user's preferences. Of course, information such as sentiment and/or source may be determined as needed (i.e., in a just-in-time manner) or may be previously established and stored in the content index 106. By way of illustration, the scores of search result set 107′ are updated according to the user-supplied diversity criteria, e.g., Doc1 now has a relevance score of ScoreA, Doc2 now has a relevance score of ScoreB, etc. Of course, while the order of the documents shown in search result set 107′ is the same as in search results set 107, this is not an indication of the order, but simply shows that the scores of the documents may change after personalization.

After the search results (more particularly, the corresponding scores of the search results) have been personalized according to the user-supplied diversity criteria, the search engine 122 then generates one or more search results pages as set forth in block 112. As will be appreciated and according to aspects of the disclosed subject matter, the search results pages are generated by the search results generator such that those search results that are deemed to be more relevant to the search query, as determine by the personalization of block 108, are included among the first results returned to the computer user in response to the search query 102. In this manner, those search results that are viewed as less relevant and, therefore, less likely to appeal to the user, are presented in subsequent search results pages (if they are requested by the computer user.)

After the search results page(s) are generated, the search results pages, such as search results page 114, are returned to the computer user.

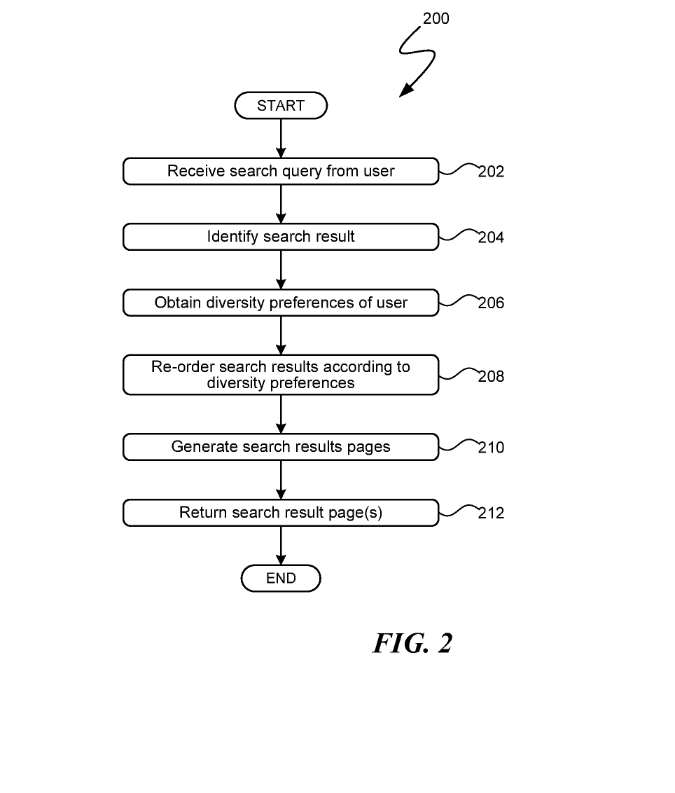

The process 100 shown in FIG. 1 is further discussed in regard to a flow diagram. In particular, FIG. 2 is a flow diagram illustrating an exemplary routine 200 for responding to a search query with search results personalized and, therefore, diversified according to sentiment and/or content source. Beginning in block 202, a search engine 122 receives a search query 102 from a computer user. At block 204, the search engine identifies search results that satisfy the search query.

At block 206, diversity preferences of the requesting computer user are obtained and, at block 208, the search results are diversifies according to the preferences of the user. As discussed above, diversification means that the scores associated with the identified search results are re-ordered and/or modified according to the user's preferences. For example, if the computer user has indicated that he/she would like to view only those results of user-generated content that have a positive sentiment, then the corresponding scores of those identified search results corresponding to user-generated content that have a positive sentiment are increase and those identified search results that have a neutral and/or negative sentiment are decrease.

Of course, according to various aspects of the disclosed subject matter, in addition to simply expressing a single preference with regard to sentiment, e.g., positive or negative or neutral, a computer user may provide a ratio of sentiments that the user may wish to see. For example (by way of illustration and not limitation), a computer user may establish a preference such that 50% of the search results express a positive sentiment, that 30% of the search results express a negative sentiment, and that 20% of the search results express a neutral sentiment. Of course, by way of further illustration, the user may further establish similar preferences with regard to content source: that all of the search results (of user-generated content) are obtained from non-commercial content sources, or that 40% of the search results are obtained from non-commercial content sources. Further still, combinations of sentiment and content source may be applied to the search results, all in diversifying the search results according to user-supplied diversity criteria (i.e., user preferences, either explicitly identified with regard to a particular search query or established in user preferences maintained by the search engine.) According to aspects of the disclosed subject matter, additional and/or alternative diversifications may be based according to a popularity of an item of content. In this regard, a computer user may request that less popular search results (which are less-likely to be presented to the computer user among the first sets of search results) are surfaced to the user among those search results that are first presented to the computer user. Indeed, a user may indicate that 20% of the search results should be considered less popular search results. Of course, sentiment, content source, and popularity are only examples of the various diversifications that can be made available to a computer user for diversifying the search results in response to a search query. Further still, while the diversifications are described as being applicable to user-generated content, it should be appreciated that these same diversifications may be made with regard to all content. Moreover, user-generated may be viewed as a diversification, i.e., a user may express that at least 20% of the search results to a search query be references to user-generated content in addition to commercial source content.

After diversifying the search results, at block 210, one or more search results pages are generated according to the re-ordered, diversified search results. As indicated above, those search results having the highest scores are included in the first set of search results of the first search results pages. At block 212, the one or more search results pages are returned to the requesting computer user. Thereafter, the routine 200 terminates.

Regarding routine 200 described above, as well as other processes describe herein (such as process 100), while these routines/processes are expressed in regard to discrete steps, these steps should be viewed as being logical in nature and may or may not correspond to any specific actual and/or discrete steps of a given implementation. Also, the order in which these steps are presented in the various routines and processes, unless otherwise indicated, should not be construed as the only order in which the steps may be carried out. Moreover, in some instances, some of these steps may be omitted. Those skilled in the art will recognize that the logical presentation of steps is sufficiently instructive to carry out aspects of the claimed subject matter irrespective of any particular development language in which the logical instructions/steps are encoded.

Of course, while these routines include various novel features of the disclosed subject matter, other steps (not listed) may also be carried out in the execution of the subject matter set forth in these routines. Those skilled in the art will appreciate that the logical steps of these routines may be combined together or be comprised of multiple steps. Steps of the above-described routines may be carried out in parallel or in series. Often, but not exclusively, the functionality of the various routines is embodied in software (e.g., applications, system services, libraries, and the like) that is executed on one or more processors of computing devices, such as the computing device described in regard FIG. 6 below. Additionally, in various embodiments all or some of the various routines may also be embodied in executable hardware modules including, but not limited to, system on chips (SoC's), codecs, specially designed processors and or logic circuits, and the like on a computer system.

As suggested above, these routines/processes are typically embodied within executable code modules comprising routines, functions, looping structures, selectors such as if-then and if-then-else statements, assignments, arithmetic computations, and the like. However, as suggested above, the exact implementation in executable statement of each of the routines is based on various implementation configurations and decisions, including programming languages, compilers, target processors, operating environments, and the linking or binding operation. Those skilled in the art will readily appreciate that the logical steps identified in these routines may be implemented in any number of ways and, thus, the logical descriptions set forth above are sufficiently enabling to achieve similar results.

While many novel aspects of the disclosed subject matter are expressed in routines embodied within applications (also referred to as computer programs), apps (small, generally single or narrow purposed applications), and/or methods, these aspects may also be embodied as computer-executable instructions stored by computer-readable media, also referred to as computer-readable storage media, which are articles of manufacture. As those skilled in the art will recognize, computer-readable media can host, store and/or reproduce computer-executable instructions and data for later retrieval and/or execution. When the computer-executable instructions that are hosted or stored on the computer-readable storage devices are executed by a processor of a computing device, the execution thereof causes, configures and/or adapts the executing computing device to carry out various steps, methods and/or functionality, including those steps, methods, and routines described above in regard to the various illustrated routines. Examples of computer-readable media include, but are not limited to: optical storage media such as Blu-ray discs, digital video discs (DVDs), compact discs (CDs), optical disc cartridges, and the like; magnetic storage media including hard disk drives, floppy disks, magnetic tape, and the like; memory storage devices such as random access memory (RAM), read-only memory (ROM), memory cards, thumb drives, and the like; cloud storage (i.e., an online storage service); and the like. While computer-readable media may reproduce and/or cause to deliver the computer-executable instructions and data to a computing device for execution by one or more processor via various transmission means and mediums including carrier waves and/or propagated signals, for purposes of this disclosure computer readable media expressly excludes carrier waves and/or propagated signals.

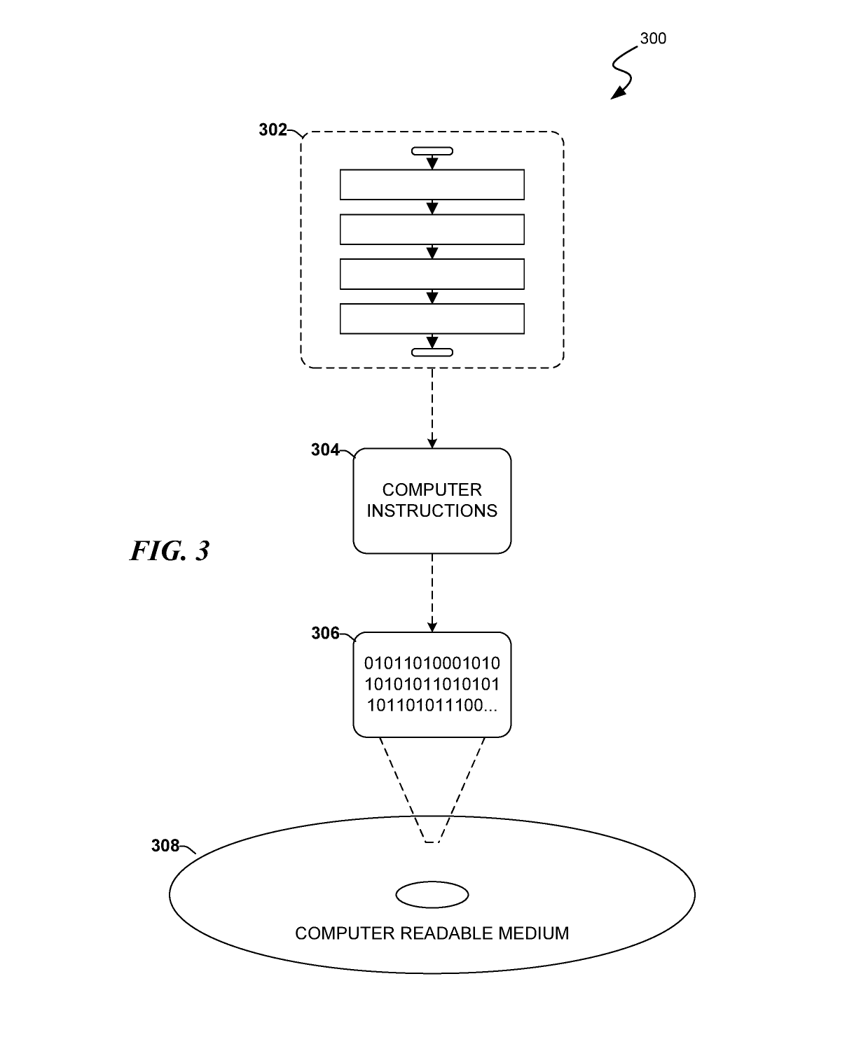

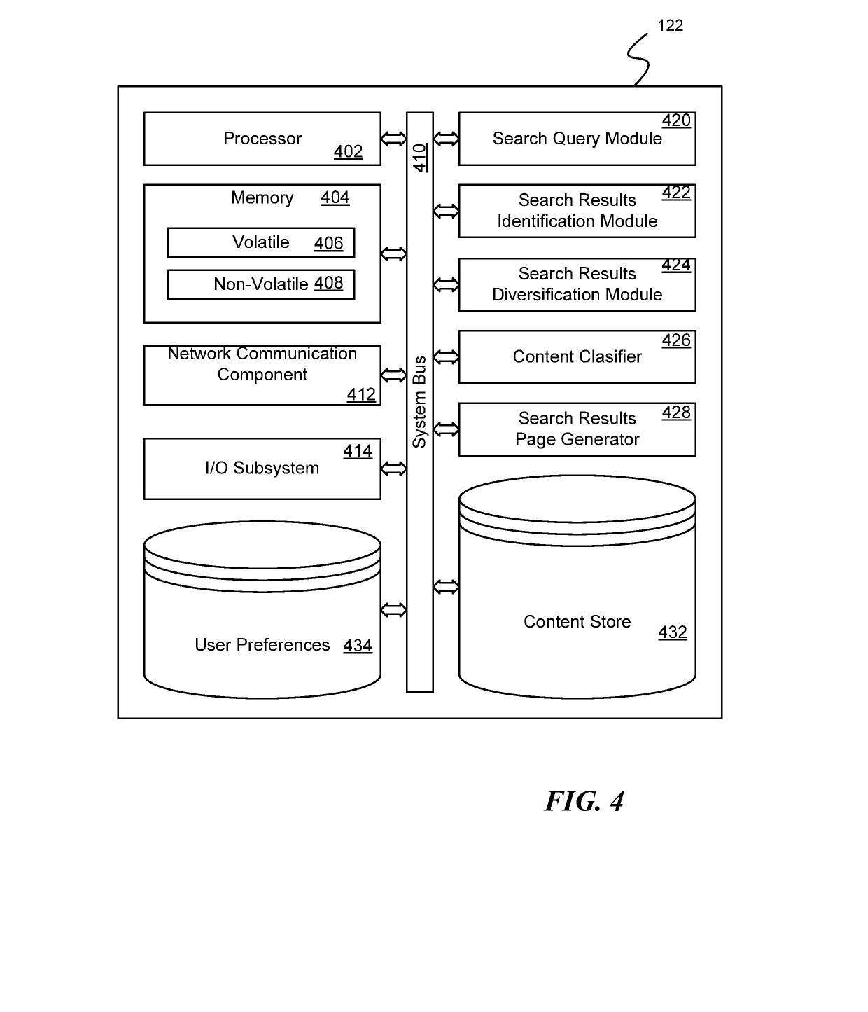

Turning to FIG. 3, FIG. 3 is a block diagram illustrating an exemplary computer readable medium encoded with instructions to configure/operate as a search engine according to aspects of the disclosed subject matter. More particularly, the implementation 300 comprises a computer-readable medium 308 (e.g., a CD-R, DVD-R or a platter of a hard disk drive), on which is encoded computer-readable data 306. This computer-readable data 306 in turn comprises a set of computer instructions 304 configured to operate according to one or more of the principles set forth herein. In one such embodiment 302, the processor-executable instructions 304 may be configured to perform a method, such as at least some of the exemplary method 200 of FIG. 2, for example. In another such embodiment, the processor-executable instructions 304 may be configured to implement a system, such as at least some of the exemplary system 400 of FIG. 4, as described below. Many such computer-readable media may be devised by those of ordinary skill in the art that are configured to operate in accordance with the techniques presented herein.

Turning to FIG. 4, FIG. 4 is a block diagram illustrating an exemplary computing device 122 configured as a search engine according to aspects of the disclosed subject matter. The exemplary computing device 122 includes one or more processors (or processing units), such as processor 402, and a memory 404. The processor 402 and memory 404, as well as other components, are interconnected by way of a system bus 410. The memory 404 typically (but not always) comprises both volatile memory 406 and non-volatile memory 408. Volatile memory 406 retains or stores information so long as the memory is supplied with power. In contrast, non-volatile memory 408 is capable of storing (or persisting) information even when a power supply is not available. Generally speaking, RAM and CPU cache memory are examples of volatile memory 406 whereas ROM, solid-state memory devices, memory storage devices, and/or memory cards are examples of non-volatile memory 408.

The processor 402 executes instructions retrieved from the memory 404 (and/or from computer-readable media, such as computer-readable media 300 of FIG. 3) in carrying out various functions of a search engine configured to diversity search results as described above. The processor 402 may be comprised of any of a number of available processors such as single-processor, multi-processor, single-core units, and multi-core units.

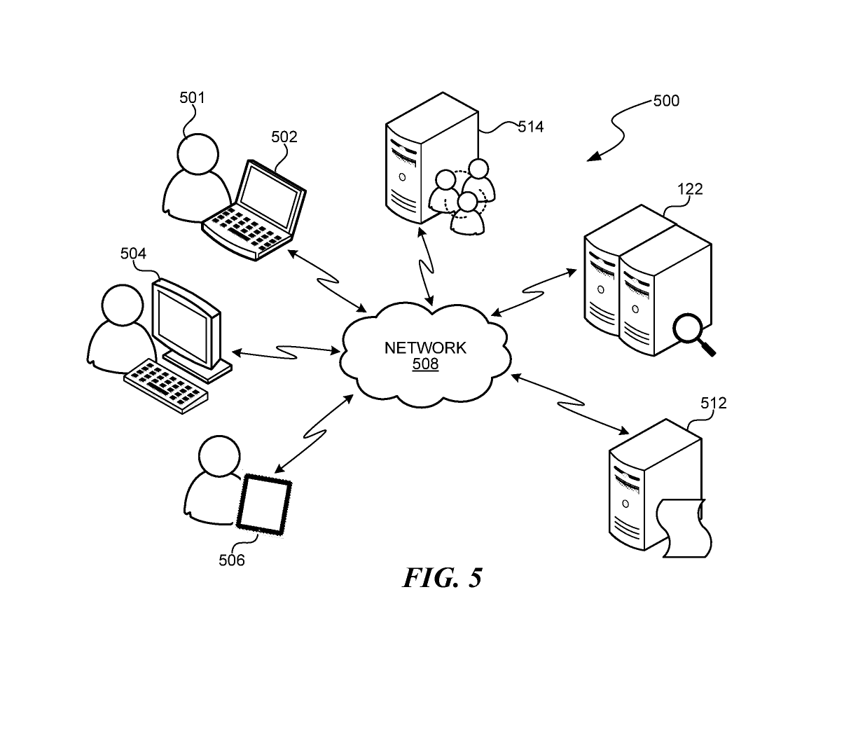

Further still, the illustrated computing device 122 includes a network communication component 412 for interconnecting this computing device with other devices and/or services over a computer network, including other user devices, such as user computing devices 502-506, as well as social network 514 and user blog site 512 shown in FIG. 5. The network communication component 412, sometimes referred to as a network interface card or NIC, communicates over a network (such as network 508) using one or more communication protocols via a physical/tangible (e.g., wired, optical, etc.) connection, a wireless connection, or both. As will be readily appreciated by those skilled in the art, a network communication component, such as network communication component 412, is typically comprised of hardware and/or firmware components (and may also include or comprise executable software components) that transmit and receive digital and/or analog signals over a transmission medium (i.e., the network.)

The computing device 122 also includes an I/O subsystem 414. As will be appreciated, an I/O subsystem comprises a set of hardware, software, and/or firmware components that enable or facilitate inter-communication between a user of the computing device 122 and the processing system of the computing device 122. Indeed, via the I/O subsystem 414 a computer operator may provide input via one or more input channels such as, by way of illustration and not limitation, touch screen/haptic input devices, buttons, pointing devices, audio input, optical input, accelerometers, and the like. Output or presentation of information may be made by way of one or more of display screens (that may or may not be touch-sensitive), speakers, haptic feedback, and the like. As will be readily appreciated, the interaction between the computer operator and the computing device 122 is enabled via the I/O subsystem 414 of the computing device.

The computing device 122 further comprises a search query module 420. The search query module 420 is an executable module that is configured (in execution) to receive search queries from computer users, such as search query 102, obtain search results pages in response to a given search query, and return one or more search results pages to the requesting computer user. In operation/execution, the search query module 420 operates in conjunction with other components of the exemplary computing device 122 including the search results identification module 422, the search results diversification module 424, the content classifier 426 and the search results page generator 428, as described below.

The search results identification module 422, in execution, operates to identify search results responsive to a search query from a computer user according to information in a content store 432. Indeed, the search results identification module 422 identifies a set of ordered search results that satisfy the search query, where each search result is associated with a score indicative of the relevance and/or popularity of the search result to the search query. According to various aspects of the disclosed subject matter, the content store 432 is an indexed store of references to content that includes diversification keys associated with the content items that are indicative of the user-supplied diversity criteria/preferences such as, by way of illustration and not limitation, sentiment, content source, and whether or not the content is user-generated content. Indeed, according to various embodiments, the content store 432 is a reverse index content store. Reverse index content stores and indexed content stores are known in the art. Of course, while diversification keys may be previously associated with the various content items represented in the content store 432, in various embodiment a content classifier 426 may be executed in an on-demand/just-in-time manner to determine the various diversification attributes of a given content item, e.g., that may be present among identified search results.

The search results diversification module 424, in execution, operates to modify (or re-order) the scores of one or more search results identified by the search results identification module 422 according to the user-supplied diversity criteria/user-preferences either provided by the requesting computer user and/or included in a user preferences store 434. These user-supplied diversity criteria/user preferences include diversification attributes such as sentiment, content source, and user-generated content. The result of the search results diversification module 424 is an updated set of ordered search results, updated according to modified scores based on the user-supplied diversity criteria/user-preferences.

As already suggested, the content classifier 426 operates to identify diversification attributes, including content sentiment, content source, and user-generated content. The content classifier 426 may be operated in a batch mode to process multiple content items and store the diversification attributes in the content index in association with the content items, or in a just-in-time/on-demand manner.

The search results page generator 428, in execution, operates to generate one or more search results pages according to a set of ordered search results provided to it. According to aspects of the disclosed subject matter, the set of ordered search results comprises the search results whose scores are modified by the search results diversification module 422. The search results pages are provided to the search query module 420 which responds to the requesting computer user with one or more of the generated search results pages.

Turning now to FIG. 5, FIG. 5 is a block diagram illustrating an exemplary network environment 500 suitable for implementing aspects of the disclosed subject matter. The network environment 500 includes user computers 502-506, each corresponding to a computer user (e.g., computer user 101). As suggested above, a computer user, such as computer user 501, submits a search query 102 by way of a user computer, such as user computer 502, to a search engine 122 over a network 508, and receives one or more search result pages in response to the query. The network environment 500 further includes other network devices and/or services, such as (by way of illustration and not limitation) a social network site 514 and a personal blog site 512. As will be readily appreciated by those skilled in the art, the search engine 122 (by way of various techniques including web crawlers) identifies content items located on the web, including user generated content such as user block 516, indexes the content items, and stores the information in a content store 432.

While various novel aspects of the disclosed subject matter have been described, it should be appreciated that these aspects are exemplary and should not be construed as limiting. Variations and alterations to the various aspects may be made without departing from the scope of the disclosed subject matter.

What is claimed:

1. A computer-implemented method for responding to a search query from a computer user with diversified search results, the method comprising:
identifying a set of search results that satisfy the search query according to the query terms of the search query, wherein the set of search results is an ordered set of search results;
re-ordering the set of search results according to diversity criteria;
generating a search results page according to the re-ordered set of search results;
returning the search results page in response to the search query.

2. The method of claim 1, wherein the diversity criteria comprises user-supplied diversity criteria.

3. The method of claim 1, wherein the diversity criteria comprises an indication of a sentiment expressed by an author regarding the subject matter of the content referenced by a search result.

4. The method of claim 3, wherein the sentiment is a positive sentiment.

5. The method of claim 3, wherein the sentiment is a negative sentiment.

6. The method of claim 3, wherein the sentiment is a neutral sentiment.

7. The method of claim 3, wherein the diversity criteria identifies a ratio of sentiments comprising any one or more of a positive sentiment, a negative sentiment, and a neutral sentiment.

8. The method of claim 1, wherein the diversity criteria comprises an indication as to the source of the content referenced by a search result.

9. The method of claim 8, wherein the source of the content comprises user-generated content.

10. The method of claim 3, wherein the diversity criteria identifies a ratio with regard to the source of the content comprising both user-generated content and commercial source content.

11. The method of claim 1 further comprising:
maintaining a set of user preferences for each of a plurality of computer users, including the computer user; and
obtaining user preferences for the computer user from the set of user preferences;
wherein the diversity criteria is included in the user preferences for the computer user.

12. A computer-readable medium bearing computer-executable instructions which, when executed on a computing system comprising at least a processor, carry out a method for responding to a search query from a computer user with diversified search results, the method comprising:
identifying a set of search results that satisfy the search query according to the query terms of the search query, wherein the set of search results is an ordered set of search results ordered according to a score associated with each search result;
re-ordering the set of search results according to diversity criteria, wherein re-ordering the set of search results according to diversity criteria comprises:
modifying the score of each search results of the set of search results according to the diversity criteria; and
ordering the set of search results according the modified scores of the search results;
generating a search results page according to the re-ordered set of search results;
returning the search results page in response to the search query.

13. The computer-readable medium of claim 12, wherein the diversity criteria comprises an indication of a sentiment expressed by an author regarding the subject matter of the content referenced by a search result.

14. The computer-readable medium of claim 12, wherein the sentiment comprises any one of a positive sentiment, a negative sentiment, or a neutral sentiment.

15. The computer-readable medium of claim 12, wherein the diversity criteria identifies a ratio of sentiments comprising any one or more of a positive sentiment, a negative sentiment, and a neutral sentiment.

16. The computer-readable medium of claim 12, wherein the diversity criteria comprises an indication as to the source of the content referenced by a search result.

17. The computer-readable medium of claim 12, wherein the source of the content comprises user-generated content.

18. The computer-readable medium of claim 12, wherein the diversity criteria identifies a ratio with regard to the source of the content comprising both user-generated content and commercial source content.

19. The computer-readable medium of claim 12, wherein the method further comprises:
maintaining a set of user preferences for each of a plurality of computer users, including the computer user; and
obtaining user preferences for the computer user from the set of user preferences;
wherein the diversity criteria is included in the user preferences for the computer user.

20. A computer system for responding with diversified search results to a search query from a computer user, the computer system comprising a processor and a memory, wherein the processor executes instructions stored in the memory as part of or in conjunction with additional components to respond to a search query, the additional components comprising:
a search query module that, in execution on the computer system, receives a search query from the computer user and responds to the computer user with one or more of the generated search results pages;
a search results identification module that, in execution on the computer system, identifies a set of ordered search results that satisfy the search query from the computer user;
a search results diversification module that, in execution on the computer system, re-orders the set of ordered search results of the search results identification module, wherein the search results diversification module re-orders the set of ordered search results according to diversity criteria associated with the computer user;
a content classifier that, in execution on the computer system, identifies diversification attributes, including content sentiment, content source, and user-generated content of content referenced by the set of ordered search results; and
a search results page generator that, in execution on the computer system, generates one or more search results according to the re-ordered set of search results.
